(19) United States
(12) Patent Application Publication
(10) Pub. No.: US 2007/0171401 A1
(43) Pub. Date: Jul. 26, 2007

(54) DISTORTION MEASURING APPARATUS, METHOD, PROGRAM, AND RECORDING MEDIUM

(75) Inventor: Junichi Ukita, Tokyo (JP)

Correspondence Address: GREENBLUM & BERNSTEIN, P.L.C., 1950 ROLAND CLARKE PLACE, RESTON, VA, 20191, US

(73) Assignee: ADVANTEST Corporation, Tokyo (JP)

(21) Appl. No.: 11/567,942

(22) Filed: Dec. 7, 2006

(30) Foreign Application Priority Data
Dec. 21, 2005 (JP) 2005-367478

(51) Int. Cl. G01N 21/00

(52) U.S. Cl. 356/73.1

(57) ABSTRACT

A distortion of a device under test (such as an optical fiber) can be precisely measured. There is provided a distortion measuring device including a signal processing unit 32 having a Brillouin scattered light spectrum recording unit 322a which records a spectrum of Brillouin scattered light generated in an optical fiber as a result of supplying incident light, a Rayleigh scattered light spectrum recording unit 322b which records a spectrum of Rayleigh scattered light generated in the optical fiber as a result of supplying the incident light, a deconvolution unit 324 which derives a Brillouin gain spectrum of the optical fiber based on the recorded spectrum of the Brillouin scattered light and the recorded spectrum of the incident light, a peak frequency deriving unit 326 which derives a peak frequency at which the derived Brillouin gain spectrum takes the maximum value, and a distortion deriving unit 328 which derives a distortion of the optical fiber based on the derived peak frequency.

### BACKGROUND OF THE INVENTION

1. Field of the Invention

The present invention relates to measurement of a distortion of an optical fiber.

2. Description of the Prior Art

Conventionally, Brillouin scattered light is coherently detected by supplying an optical fiber with pulsed light generated by pulsing continuous wave light to acquire scattered light from the optical fiber (refer to FIG. 8 of Patent Document 1, for example). The coherent detection is carried out by multiplexing the Brillouin scattered light (optical frequencies: fc+fb and fc−fb) and intensity-modulated light acquired by applying intensity modulation to the continuous wave light (optical frequency: fc) at a predetermined frequency p, for example. It should be noted that the intensity-modulated light includes a carrier light component having the optical frequency fc, and side band light components having the optical frequencies fc+p and fc−p.

A signal corresponding to the Brillouin scattered light is extracted by a filter from a result of the coherent detection thereby acquiring a power spectrum of the Brillouin scattered light. It should be noted that the power spectrum of the Brillouin scattered light is acquired while the predetermined frequency “p” is being changed. Moreover, a peak frequency where the power of the Brillouin scattered light takes the maximum value is acquired by fitting a predetermined function (such as a Lorentzian function) to the power spectrum of the Brillouin scattered light. A value of distortion of the optical fiber is acquired based on the peak frequency.

(Patent Document 1) Japanese Laid-Open Patent Publication (Kokai) No. 2001-165808 (refer to FIG. 8)

### SUMMARY OF THE INVENTION

However, according to the above prior art, when the pulse width of the pulsed light gets narrower, the spectrum width of the pulsed light gets wider, and the spectrum width of the Brillouin scattered light thus gets wider. For example, if the pulse width becomes approximately 10 ns, the spectrum width of the pulsed light extends to approximately 100 MHz, and the spectrum width of the Brillouin scattered light thus extends to approximately 100 MHz to 150 MHz.

Moreover, an optical device (such as a semiconductor optical amplifier or an optical intensity modulator) is used to convert the continuous wave light into the pulsed light. The chirp characteristic (fluctuation of the optical frequency on a rise and a fall of the pulsed light) of the optical device causes the spectrum width of the pulsed light to get wider, and thus also causes the spectrum width of the Brillouin scattered light to get wider. Moreover, the spectrum shape of the Brillouin scattered light changes.

In this way, due to the increased spectrum width of the Brillouin scattered light and the change of the spectrum shape of the Brillouin scattered light, precision of the fitting to the power spectrum of the Brillouin scattered light degrades. As a result, precision to detect the peak frequency degrades, and further, precision to measure the distortion of the optical fiber degrades.

It is an object of the present invention to precisely measure a distortion of a device under test (such as an optical fiber).

According to the present invention, a distortion measuring device includes: a Brillouin scattered light spectrum recording unit that records a spectrum of Brillouin scattered light generated in a device under test as a result of supplying incident light; an incident light spectrum recording unit that records a spectrum of the incident light; a Brillouin gain spectrum deriving unit that derives a Brillouin gain spectrum of the device under test based on the recorded spectrum of the Brillouin scattered light and the recorded spectrum of the incident light; a peak frequency deriving unit that derives a peak frequency at which the derived Brillouin gain spectrum takes the maximum value; and a distortion deriving unit that derives a distortion of the device under test based on the derived peak frequency.

According to the thus constructed distortion measuring device, a Brillouin scattered light spectrum recording unit records a spectrum of Brillouin scattered light generated in a device under test as a result of supplying incident light. An incident light spectrum recording unit records a spectrum of the incident light. A Brillouin gain spectrum deriving unit derives a Brillouin gain spectrum of the device under test based on the recorded spectrum of the Brillouin scattered light and the recorded spectrum of the incident light. A peak frequency deriving unit derives a peak frequency at which the derived Brillouin gain spectrum takes the maximum value. A distortion deriving unit derives a distortion of the device under test based on the derived peak frequency.

According to the distortion measuring device of the present invention, the incident light spectrum recording unit may record a spectrum of Rayleigh scattered light generated in the device under test as the incident light spectrum.

According to the present invention, a distortion measuring device includes: a Brillouin scattered light spectrum recording unit that records a spectrum of Brillouin scattered light generated in a device under test as a result of supplying incident light; a Rayleigh scattered light spectrum recording unit that records a spectrum of Rayleigh scattered light generated in the device under test as a result of supplying the incident light; a Brillouin gain spectrum deriving unit that derives a Brillouin gain spectrum of the device under test based on the recorded spectrum of the Brillouin scattered light and the recorded spectrum of the Rayleigh scattered light; a peak frequency deriving unit that derives a peak frequency at which the derived Brillouin gain spectrum takes the maximum value; and a distortion deriving unit that derives a distortion of the device under test based on the derived peak frequency.

According to the thus constructed distortion measuring device, a Brillouin scattered light spectrum recording unit records a spectrum of Brillouin scattered light generated in a device under test as a result of supplying incident light. A Rayleigh scattered light spectrum recording unit records a spectrum of Rayleigh scattered light generated in the device under test as a result of supplying the incident light. A Brillouin gain spectrum deriving unit derives a Brillouin gain spectrum of the device under test based on the recorded spectrum of the Brillouin scattered light and the recorded spectrum of the Rayleigh scattered light. A peak frequency deriving unit derives a peak frequency at which the derived Brillouin gain spectrum takes the maximum value. A distortion deriving unit derives a distortion of the device under test based on the derived peak frequency.

According to the distortion measuring device of the present invention, the spectrum of the Brillouin scattered light and the spectrum of the Rayleigh scattered light may relate to the same position in the device under test.

According to the present invention, the distortion measuring device may include: a continuous wave light source that generates continuous wave light; an optical pulse generator that converts the continuous wave light into pulsed light; an optical frequency shifter that receives the continuous wave light, and outputs shifted light including the continuous wave light, first side band light having an optical frequency higher than an optical frequency of the continuous wave light by a predetermined optical frequency, and second side band light having an optical frequency lower than the optical frequency of the continuous wave light by the predetermined optical frequency; a heterodyne optical receiver that receives scattered light from an incident end of the device under test which the pulsed light enters, further receives the shifted light from the optical frequency shifter, and outputs an electric signal having a frequency which is a difference between the optical frequency of the scattered light and the optical frequency of the shifted light; a Brillouin scattered light spectrum extracting unit that extracts an electric signal corresponding to the Brillouin scattered light from the electric signal; and a Rayleigh scattered light spectrum extracting unit that extracts an electric signal corresponding to the Rayleigh scattered light from the electric signal.

According to the present invention, a distortion measuring method includes: a Brillouin scattered light spectrum recording step of recording a spectrum of Brillouin scattered light generated in a device under test as a result of supplying incident light; an incident light spectrum recording step of recording a spectrum of the incident light; a Brillouin gain spectrum deriving step of deriving a Brillouin gain spectrum of the device under test based on the recorded spectrum of the Brillouin scattered light and the recorded spectrum of the incident light; a peak frequency deriving step of deriving a peak frequency at which the derived Brillouin gain spectrum takes the maximum value; and a distortion deriving step of deriving a distortion of the device under test based on the derived peak frequency.

The present invention is a computer-readable medium having a program of instructions for execution by the computer to perform a distortion measuring process, the distortion measuring process including: a Brillouin scattered light spectrum recording step of recording a spectrum of Brillouin scattered light generated in a device under test as a result of supplying incident light; an incident light spectrum recording step of recording a spectrum of the incident light; a Brillouin gain spectrum deriving step of deriving a Brillouin gain spectrum of the device under test based on the recorded spectrum of the Brillouin scattered light and the recorded spectrum of the incident light; a peak frequency deriving step of deriving a peak frequency at which the derived Brillouin gain spectrum takes the maximum value; and a distortion deriving step of deriving a distortion of the device under test based on the derived peak frequency.

According to the present invention, a distortion measuring method includes: a Brillouin scattered light spectrum recording step of recording a spectrum of Brillouin scattered light generated in a device under test as a result of supplying incident light; a Rayleigh scattered light spectrum recording step of recording a spectrum of Rayleigh scattered light generated in the device under test as a result of supplying the incident light; a Brillouin gain spectrum deriving step of deriving a Brillouin gain spectrum of the device under test based on the recorded spectrum of the Brillouin scattered light and the recorded spectrum of the Rayleigh scattered light; a peak frequency deriving step of deriving a peak frequency at which the derived Brillouin gain spectrum takes the maximum value; and a distortion deriving step of deriving a distortion of the device under test based on the derived peak frequency.

The present invention is a computer-readable medium having a program of instructions for execution by the computer to perform a distortion measuring process, the distortion measuring process including: a Brillouin scattered light spectrum recording step of recording a spectrum of Brillouin scattered light generated in a device under test as a result of supplying incident light; a Rayleigh scattered light spectrum recording step of recording a spectrum of Rayleigh scattered light generated in the device under test as a result of supplying the incident light; a Brillouin gain spectrum deriving step of deriving a Brillouin gain spectrum of the device under test based on the recorded spectrum of the Brillouin scattered light and the recorded spectrum of the Rayleigh scattered light; a peak frequency deriving step of deriving a peak frequency at which the derived Brillouin gain spectrum takes the maximum value; and a distortion deriving step of deriving a distortion of the device under test based on the derived peak frequency.

### BRIEF DESCRIPTION OF THE DRAWINGS

FIG. 1 is a diagram showing a configuration of a distortion measuring device 1 according to an embodiment of the present invention;

FIG. 2 is a diagram showing a pass band of the filter circuit 30 upon acquiring the electric signal corresponding to the Brillouin scattered light;

FIG. 3 is a diagram showing a pass band of the filter circuit 30 upon acquiring the electric signal corresponding to the Rayleigh scattered light;

FIG. 4 is a functional block diagram showing a configuration of the signal processing unit 32;

FIG. 5(a) shows a spectrum of the Brillouin scattered light actually acquired, and FIG. 5(b) shows a spectrum of ideal Brillouin scattered light;

FIG. 6(a) shows a spectrum of the Rayleigh scattered light actually acquired, and FIG. 6(b) shows a spectrum of ideal Rayleigh scattered light; and

FIG. 7 is a chart showing the Brillouin gain spectrum of the optical fiber 2.

### DETAILED DESCRIPTION OF THE PREFERRED EMBODIMENTS

A description will now be given of an embodiment of the present invention with reference to drawings.

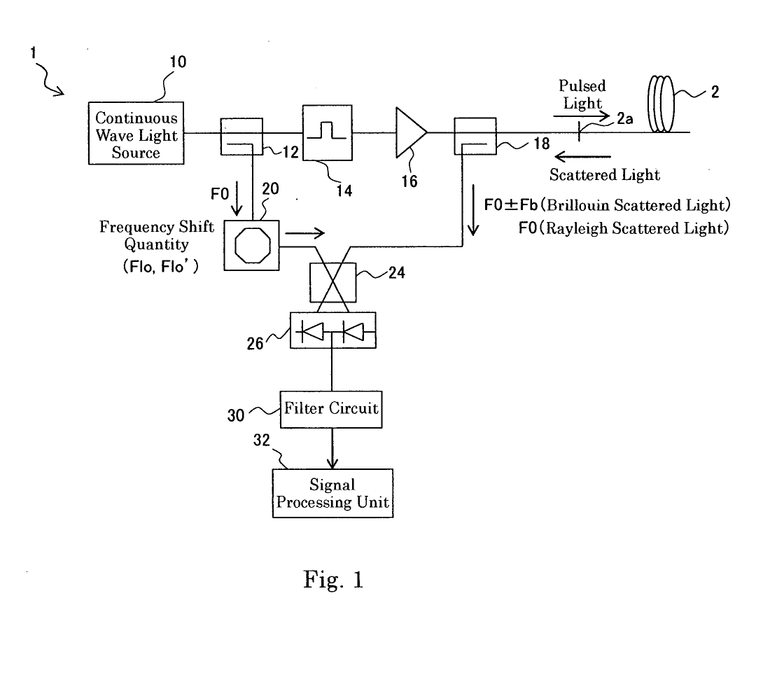

FIG. 1 is a diagram showing a configuration of a distortion measuring device 1 according to the embodiment of the present invention. The distortion measuring device 1 is connected to an optical fiber (device under test) 2. Moreover, the distortion measuring device 1 includes a continuous wave light source 10, an optical coupler 12, an optical pulse generator 14, an optical amplifier 16, an optical coupler 18, an optical frequency shifter 20, an optical coupler 24, a heterodyne optical receiver 26, a filter circuit 30, and a signal processing unit 32.

The continuous wave light source 10 generates continuous wave (CW) light. It should be noted that the optical frequency of the continuous wave light is F0. The optical coupler 12 receives the continuous wave light from the continuous wave light source 10, and supplies the optical pulse generator 14 and the optical frequency shifter 20 with the continuous wave light. The optical pulse generator 14 converts the continuous wave light into pulsed light. The optical amplifier 16 amplifies the pulsed light.

The optical coupler 18 receives the pulsed light from the optical amplifier 16, and supplies the optical fiber 2 with the pulsed light via an incident end 2a. Rayleigh scattered light (optical frequency F0) and Brillouin scattered light (optical frequency F0±Fb) is emitted from the incident end 2a of the optical fiber 2, and is supplied to the optical coupler 18. The optical coupler 18 supplies the optical coupler 24 with the received scattered light.

The optical frequency shifter 20 receives the continuous wave light from the optical coupler 12. Then, the optical frequency shifter 20 outputs shifted light. The shifted light includes continuous wave light, first side band light, and second side band light. The optical frequencies of the first side band light and the second side band light are respectively shifted from the optical frequency F0 of the continuous wave light by predetermined frequency shift quantities Flo and Flo′.

Namely, the first side band light is light having an optical frequency F0+Flo, which is higher than the optical frequency F0 of the continuous wave light by the predetermined optical frequency of Flo. Alternatively, the first side band light is light having an optical frequency F0+Flo′, which is higher than the optical frequency F0 of the continuous wave light by the predetermined optical frequency of Flo′.

The second side band light is light having an optical frequency F0−Flo, which is lower than the optical frequency F0 of the continuous wave light by the predetermined optical frequency of Flo. Alternatively, the second side band light is light having an optical frequency F0−Flo′, which is lower than the optical frequency F0 of the continuous wave light by the predetermined optical frequency of Flo′.

It should be noted that Flo and Flo′ are different from each other.

The optical coupler 24 receives the shifted light from the optical frequency shifter 20, receives the scattered light from the optical coupler 18, multiplexes them, and supplies the heterodyne optical receiver 26 with the multiplexed light.

The heterodyne optical receiver 26 receives the light multiplexed by the optical coupler 24. Namely, the heterodyne optical receiver 26 receives the scattered light from the incident end 2a of the optical fiber 2, which the pulsed light enters, via the optical coupler 24. Further, the heterodyne optical receiver 26 receives the shifted light from the optical frequency shifter 20 via the optical coupler 24. Then, the heterodyne optical receiver 26 outputs an electric signal having a frequency which is difference between the optical frequency of the scattered light and the optical frequency of the shifted light.

The frequency of the electrical signal of a component corresponding to the Brillouin scattered light is |Flo−Fb| (=|F0+Flo−(F0+Fb)|), and the frequency of the electric signal of a component corresponding to the Rayleigh scattered light is Flo′ (=F0+Flo′−F0).

The filter circuit 30 passes an electric signal output from the heterodyne optical receiver 26 in bands close to a predetermined frequency, and does not pass a signal in the other bands. The predetermined frequency in this case is |Flo−Fb| or Flo′.

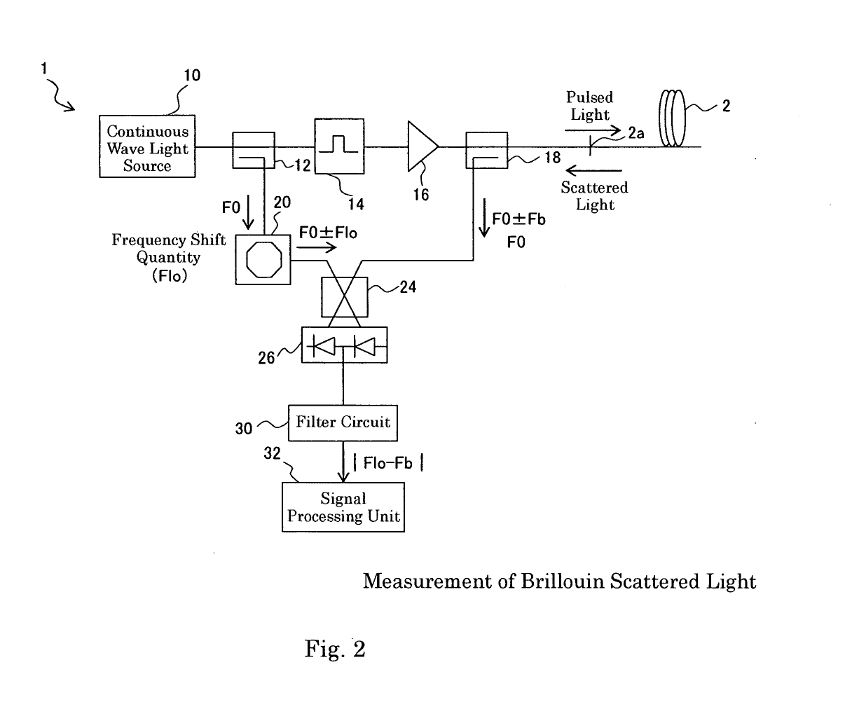

FIG. 2 is a diagram showing a pass band of the filter circuit 30 upon acquiring the electric signal corresponding to the Brillouin scattered light. With reference to FIG. 2, upon acquiring the electrical signal corresponding to the Brillouin scattered light, the frequency shift quantity of the optical frequency shifter 20 is Flo, and the predetermined frequency is |Flo−Fb|. Then, since the frequency of the electric signal of a component corresponding to the Brillouin scattered light is |Flo−Fb| (=|F0+Flo−(F0+Fb)|), the electric signal corresponding to the Brillouin scattered light is acquired.

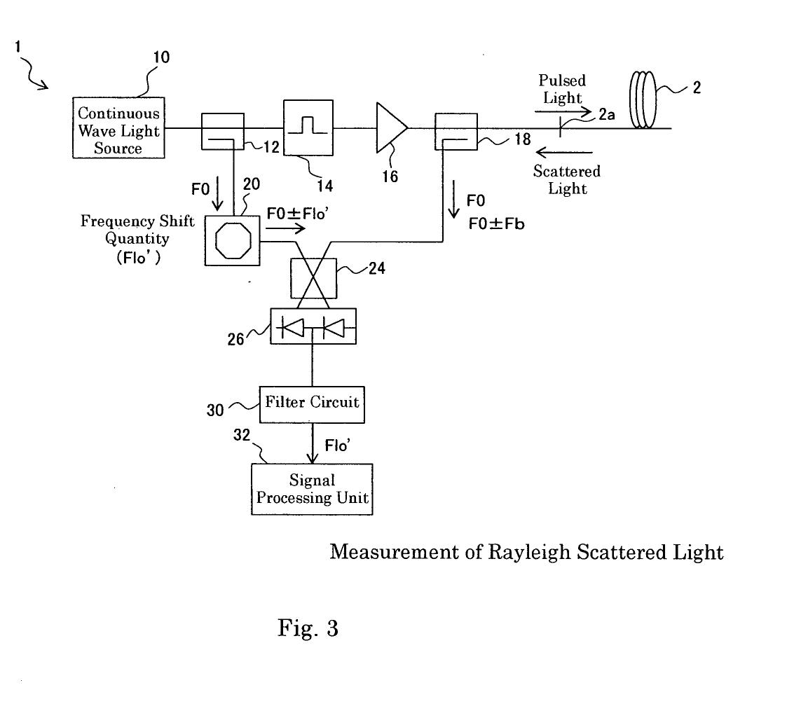

FIG. 3 is a diagram showing a pass band of the filter circuit 30 upon acquiring the electric signal corresponding to the Rayleigh scattered light. With reference to FIG. 3, upon acquiring the electric signal corresponding to the Rayleigh scattered light, the frequency shift quantity of the optical frequency shifter 20 is Flo′, and the predetermined frequency is Flo′. Then, since the frequency of the electric signal of a component corresponding to the Rayleigh scattered light is Flo′ (=F0+Flo′−F0), the electric signal corresponding to the Rayleigh scattered light is acquired.

Thus, the filter circuit 30 serves as extracting means which extracts the electric signal corresponding to the Brillouin scattered light and the electric signal corresponding to the Rayleigh scattered light. These electric signals correspond to spectra.

The signal processing unit 32 receives the output from the filter circuit 30, and derives a distortion of the optical fiber (device under test) 2.

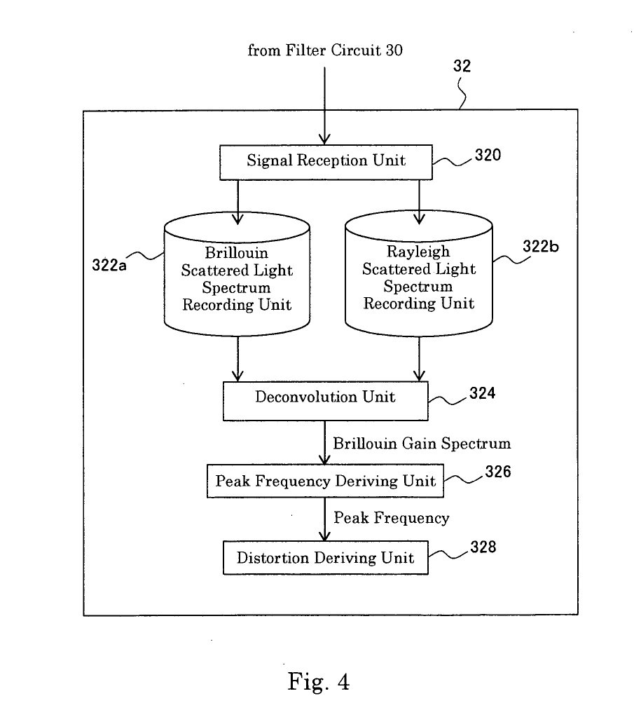

FIG. 4 is a functional block diagram showing a configuration of the signal processing unit 32. The signal processing unit 32 includes a signal reception unit 320, a Brillouin scattered light spectrum recording unit 322a, a Rayleigh scattered light spectrum recording unit 322b, a deconvolution unit (Brillouin gain spectrum deriving means) 324, a peak frequency deriving unit 326, and a distortion deriving unit 328.

The signal reception unit 320 receives the output of the filter circuit 30. If the output from the filter circuit 30 is the electric signal corresponding to the Brillouin scattered light, the electric signal is recorded in the Brillouin scattered light spectrum recording unit 322a. If the output from the filter circuit 30 is the electric signal corresponding to the Rayleigh scattered light, the electric signal is recorded in the Rayleigh scattered light spectrum recording unit 322b.

The Brillouin scattered light spectrum recording unit 322a records the electric signal corresponding to the Brillouin scattered light output from the filter circuit 30. This electric signal corresponds to the spectrum of the Brillouin scattered light. Thus, the Brillouin scattered light spectrum recording unit 322a records the spectrum of the Brillouin scattered light generated in the optical fiber 2 as a result of supplying the incident light.

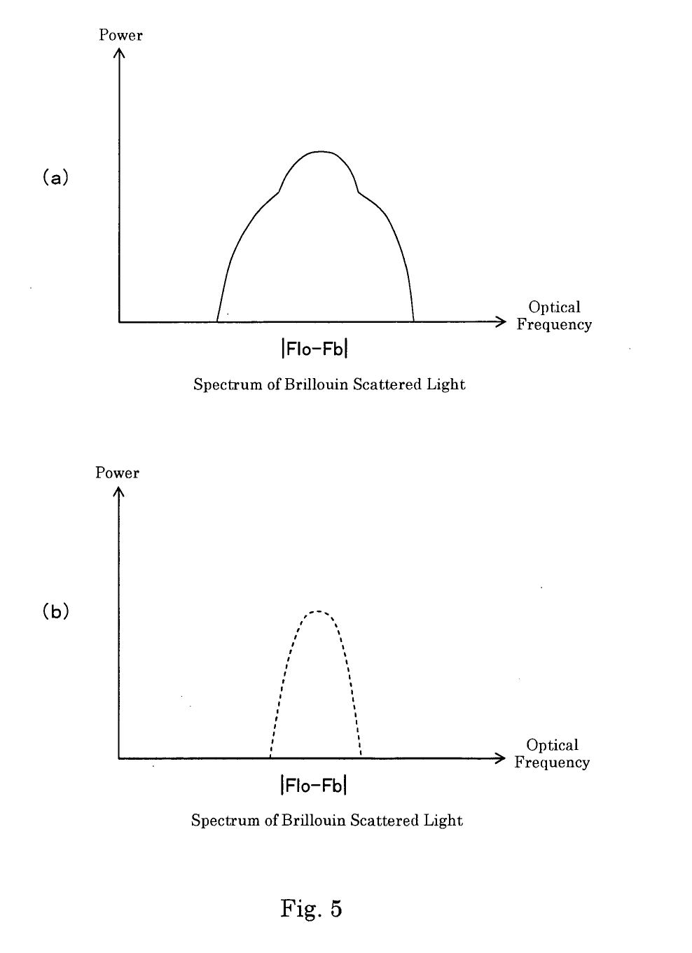

FIG. 5(a) shows a spectrum of the Brillouin scattered light actually acquired, and FIG. 5(b) shows a spectrum of ideal Brillouin scattered light. It should be noted that the vertical axis represents the power and the horizontal axis represents the optical frequency (|Flo−Fb|) in FIGS. 5(a) and 5(b).

The spectrum of the Brillouin scattered light shown in FIG. 5(a) is acquired by obtaining the electric signal while the Flo is caused to change. The spectrum shown in FIG. 5(a) has an increased width, which is different from the ideal spectrum (refer to FIG. 5(b)), and the spectrum also has a different shape in a neighborhood where the spectrum takes the maximum value. This is caused by a narrow pulse width of the incident light, and the chirp characteristic of the optical pulse generator 14.

The Rayleigh scattered light spectrum recording unit 322b records the electric signal corresponding to the Rayleigh scattered light output from the filter circuit 30. This electric signal corresponds to the spectrum of the Rayleigh scattered light. Thus, the Rayleigh scattered light spectrum recording unit 322b records the spectrum of the Rayleigh scattered light generated in the optical fiber 2 as a result of supplying the incident light.

It should be noted that the Rayleigh scattered light spectrum recording unit 322b has to record the spectrum of the incident light. According to the present embodiment, the spectrum of the Rayleigh scattered light is recorded as the spectrum of the incident light.

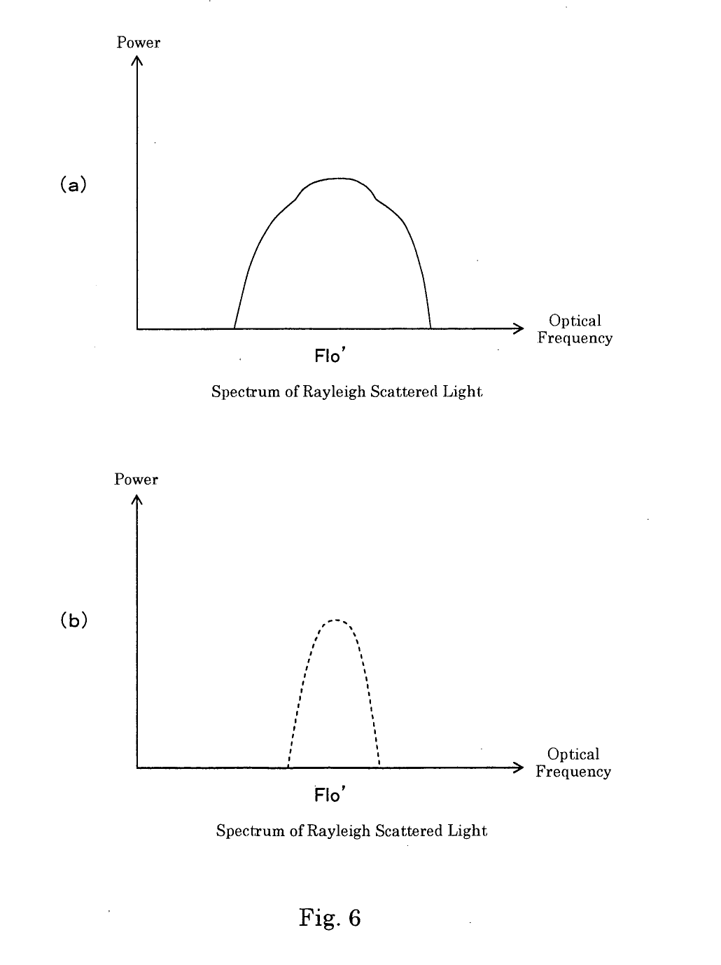

FIG. 6(a) shows a spectrum of the Rayleigh scattered light actually acquired, and FIG. 6(b) shows a spectrum of ideal Rayleigh scattered light. It should be noted that the vertical axis represents the power and the horizontal axis represents the optical frequency (Flo′) in FIGS. 6(a) and 6(b).

The spectrum of the Rayleigh scattered light shown in FIG. 6(a) is acquired by obtaining the electric signal while the Flo′ is caused to change. The spectrum shown in FIG. 6(a) has an increased width, which is different from the ideal spectrum (refer to FIG. 6(b)), and the spectrum also has a different shape in a neighborhood where the spectrum takes the maximum value.

It should be noted that the spectrum of the Brillouin scattered light shown in FIG. 5(a) and the Rayleigh scattered light shown in FIG. 6(a) are acquired at the same point on the optical fiber 2.

The deconvolution unit (Brillouin gain spectrum deriving means) 324 derives a Brillouin gain spectrum of the optical fiber 2 based on the spectrum of the Brillouin scattered light recorded in the Brillouin scattered light spectrum recording unit 322a and the spectrum of the Rayleigh scattered light recorded in the Rayleigh scattered light spectrum recording unit 322b.

There holds a relationship represented by the following equation (1) between the spectrum H of the Brillouin scattered light and the spectrum P of the incident light.
H(ν)=∫_{-∞}^{∞}P(f, f0)g(ν,f−s_{B})df (1)

It should be noted that ν denotes the optical frequency of the Brillouin scattered light, f denotes the optical frequency of the incident light, f0 denotes the optical frequency where the power of the incident light takes the maximum value, g denotes the Brillouin gain spectrum, and s_{B} denotes a Brillouin frequency shift, namely, a difference between f0 and νB (νB denotes an optical frequency at which the power of the Brillouin scattered light takes the maximum value).

Moreover, according to the present embodiment, in place of the incident light spectrum P, the spectrum of the Rayleigh scattered light is used.

On this occasion, the Laplace transform is applied to both sides of the equation (1) to obtain the following equation (2). Then, an equation (3) is obtained by transforming the equation (2). The processing represented by the equation (3) is referred to as deconvolution.
L(H(ν))=L(P)L(g) (2)
L⁻¹(P)L(H(ν))=L(g) (3)

It should be noted that L denotes the Laplace transform, and L⁻¹ denotes the inverse Laplace transform. Moreover, respective arguments of the incident light spectrum P and the Brillouin gain spectrum g are not shown in the equations (2) and (3).

The left side of the equation (3) can be obtained by assigning the spectrum of the Rayleigh scattered light recorded in the Rayleigh scattered light spectrum recording unit 322b to the incident light spectrum P on the left side of the equation (3), and by assigning the spectrum of the Brillouin scattered light recorded in the Brillouin scattered light spectrum recording unit 322a to the spectrum H of the Brillouin scattered light on the left side of the equation (3). It is possible to derive the Brillouin gain spectrum g from the left side of the equation (3).

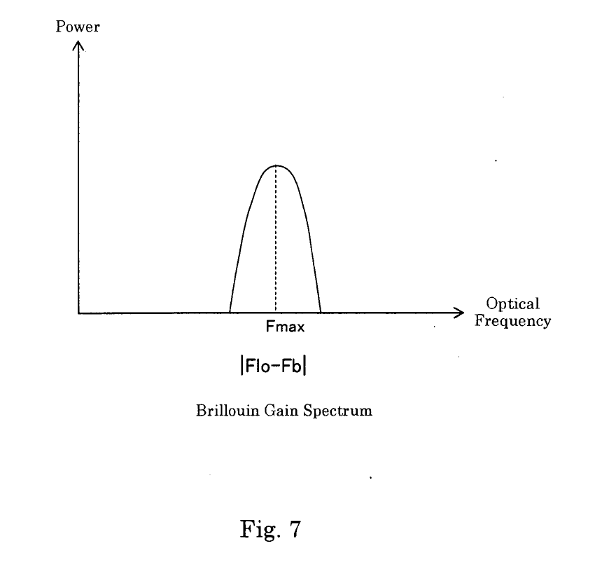

FIG. 7 is a chart showing the Brillouin gain spectrum of the optical fiber 2. Since the influence of the incident light spectrum P (namely, the influence of the narrow pulse width of the incident light, and the chirp characteristic of the optical pulse generator 14) is removed from the spectrum H of the Brillouin scattered light by the deconvolution in the Brillouin gain spectrum, the Brillouin gain spectrum has the same shape as the spectrum of the ideal Brillouin scattered light (refer to FIG. 5(b)).

The peak frequency deriving unit 326 derives a peak frequency at which the Brillouin gain spectrum derived by the deconvolution unit 324 takes the maximum value. Specifically, the Brillouin gain spectrum is approximated by a Lorentzian function. A frequency at which the Lorentzian function takes the maximum value is designated as the peak frequency.

According to the example shown in FIG. 7, the peak frequency is Fmax.

The distortion deriving unit 328 derives the distortion of the optical fiber 2 based on the peak frequency derived by the peak frequency deriving unit 326.

First, there holds a relationship represented by the equation (4) between the distortion ε of the optical fiber 2 and the Brillouin frequency shift s_{B}.
s_{B}(ε)=s_{B}(0)+(ds_{B}/dε)·ε (4)

It should be noted that S_{B}(0) is a Brillouin frequency shift when the distortion ε is 0. Thus, if the Brillouin frequency shift s_{B} is given, it is possible to derive the distortion ε of the optical fiber 2.

The Brillouin frequency shift is a difference between the optical frequency f0 at which the power of the incident light takes the maximum value, and the optical frequency νB at which the power of the Brillouin scattered light takes the maximum value. The optical frequency f0 at which the power of the incident light takes the maximum value is F0. If the optical frequency νVB at which the power of the Brillouin scattered light takes the maximum value is given, it is possible to derive the distortion ε of the optical fiber 2.

The power P_{B} of the Brillouin scattered light has a relationship represented by the following equation (5).

$${P}_{B} ( Z , υ ) = g ( υ , {υ}_{B} ) \frac{c}{2 n} P exp ( - 2 α sZ ) \qquad ( 5 )$$

It should be noted that the z denotes the distance from the incident end 2a of the optical fiber 2, c denotes the velocity of light, n denotes the refractive index of the optical fiber 2, P denotes the entire power of the incident pulsed light, and αs denotes the attenuation coefficient of the optical fiber 2.

As the equation (5) shows, the power P_{B} of the Brillouin scattered light takes the maximum value at the peak frequency at which the Brillouin gain spectrum g takes the maximum value. According to the example shown in FIG. 7, the peak frequency is Fmax. Thus, the Brillouin frequency shift s_{B} is F0−Fmax. If the Brillouin frequency shift s_{B} is given, it is possible to derive the distortion ε ε of the optical fiber 2 according to the equation (4).

A description will now be given of an operation of the embodiment of the present invention.

First, the continuous wave light source 10 generates the continuous wave light.

The continuous wave light is supplied to the optical pulse generator 14 via the optical coupler 12. The optical pulse generator 14 converts the continuous wave light into pulsed light. The pulsed light is amplified by the optical amplifier 16, passes the photo coupler 18, and is made incident to the incident end 2a of the optical fiber 2.

The scattered light (the Rayleigh scattered light and the Brillouin scattered light) is emitted from the incident end 2a of the optical fiber 2, and is supplied to the optical coupler 18. The optical coupler 18 supplies the optical coupler 24 with the received scattered light.

Moreover, the continuous wave light is supplied to the optical frequency shifter 20 via the optical coupler 12.

(i) Acquisition of Spectrum of Brillouin Scattered Light (refer to FIG. 2)

The optical frequency shifter 20 receives the continuous wave light (optical frequency F0), and outputs the shifted light (continuous light (optical frequency F0)), the first side band light (optical frequency F0+Flo), and the second side band light (optical frequency F0−Flo). The shifted light output from the optical frequency shifter 20 is supplied to the optical coupler 24.

The optical coupler 24 receives the shifted light from the optical frequency shifter 20, receives the scattered light from the optical coupler 18, multiplexes them, and supplies the heterodyne optical receiver 26 with the multiplexed light.

Then, the heterodyne optical receiver 26 receives the light multiplexed by the optical coupler 24, and outputs the electric signal having the frequency which is the difference between the optical frequency of the scattered light and the optical frequency of the shifted light.

On this occasion, first, the filter circuit 30 passes the electric signal output from the heterodyne optical receiver 26 in the bands close to the frequency |Flo−Fb| (=|F0+Flo−(F0+Fb)|), and does not pass signals in the other bands (refer to FIG. 2). Then, the filter circuit 30 serves as the extracting means which extracts the electric signal corresponding to the Brillouin scattered light. The electric signal corresponding to the Brillouin scattered light is recorded in the Brillouin scattered light spectrum recording unit 322a of the signal processing unit 32 via the signal reception unit 320 of the signal processing unit 32.

(ii) Acquisition of Spectrum of Rayleigh Scattered Light (refer to FIG. 3)

Then, the optical frequency shifter 20 receives the continuous wave light (optical frequency F0), and outputs the shifted light (continuous wave light (optical frequency F0)), the first side band light (optical frequency F0+Flo′), and the second side band light (optical frequency F0−Flo′). The shifted light output from the optical frequency shifter 20 is supplied to the optical coupler 24.

The optical coupler 24 receives the shifted light from the optical frequency shifter 20, receives the scattered light from the optical coupler 18, multiplexes them, and supplies the heterodyne optical receiver 26 with the multiplexed light.

Then, the heterodyne optical receiver 26 receives the light multiplexed by the optical coupler 24, and outputs the electric signal having the frequency which is the difference between the optical frequency of the scattered light and the optical frequency of the shifted light.

On this occasion, the filter circuit 30 first passes the electric signal output from the heterodyne optical receiver 26 in the bands close to the frequency Flo′ (=F0+Flo′−F0), and does not pass signals in the other bands (refer to FIG. 3). Thus, the filter circuit 30 serves as the extracting means which extracts the electric signal corresponding to the Rayleigh scattered light. The electric signal corresponding to the Rayleigh scattered light is recorded in the Rayleigh scattered light spectrum recording unit 322b of the signal processing unit 32 via the signal reception unit 320 of the signal processing unit 32.

(iii) Deriving Distortion of Optical Fiber 2 (refer to FIG. 4)

The deconvolution unit 324 derives the Brillouin gain spectrum of the optical fiber 2 (refer to equation (3) and FIG. 7) based on the spectrum of the Brillouin scattered light (refer to FIG. 5(a)) recorded in the Brillouin scattered light spectrum recording unit 322a and the spectrum of the Rayleigh scattered light (refer to FIG. 6(a)) recorded in the Rayleigh scattered light spectrum recording unit 322b.

The peak frequency deriving unit 326 derives the peak frequency Fmax at which the Brillouin gain spectrum derived by the deconvolution unit 324 takes the maximum value (refer to FIG. 7).

The distortion deriving unit 328 derives the distortion of the optical fiber 2 based on the peak frequency derived by the peak frequency deriving unit 326 (refer to the equation (4)).

According to the embodiment of the present invention, the distortion of the optical fiber 2 is derived based on the peak frequency Fmax of the Brillouin gain spectrum.

Since the influence of the incident light spectrum P (namely, the influence of the narrow pulse width of the incident light, and the chirp characteristic of the optical pulse generator 14) is removed from the spectrum H of the Brillouin scattered light by the deconvolution in the Brillouin gain spectrum (refer to FIG. 7), the Brillouin gain spectrum has the same shape as the spectrum of the ideal Brillouin scattered light (refer to FIG. 5(b)). As a result, the peak frequency Fmax of the Brillouin gain spectrum is precisely derived, and, consequently, the distortion of the optical fiber 2 can precisely be derived.

It is apparent that the distortion of the optical fiber 2 can precisely be derived according to the embodiment of the present invention compared with a case where the frequency at which this spectrum takes the maximum value is acquired directly based on the spectrum (refer to FIG. 5(a)) of the Brillouin scattered light recorded in the Brillouin scattered light spectrum recording unit 322a.

Namely, the shape of the spectrum (refer to FIG. 5(a)) of the Brillouin scattered light recorded in the Brillouin scattered light spectrum recording unit 322a is wider and different in shape due to the narrow pulse width of the incident light, and the chirp characteristic of the optical pulse generator 14. Thus, if the frequency at which this spectrum takes the maximum value is acquired directly from this spectrum, the approximation by means of the Lorentzian function is not precisely carried out, and the frequency at which the spectrum takes the maximum value is thus not derived precisely.

However, according to the embodiment of the present invention, since the peak frequency is derived based on the Brillouin gain spectrum (refer to FIG. 7), which is narrower and smaller in change of the shape, the approximation by means of the Lorentzian function is precisely carried out, the frequency at which the spectrum takes the maximum value is derived precisely, and the distortion of the optical fiber 2 thus can be precisely derived.

It should be noted that the above-described embodiment may be realized in the following manner. A computer is provided with a CPU, a hard disk, and a media (such as a floppy disk (registered trade mark) and a CD-ROM) reader, and the media reader is caused to read a medium recording a program realizing the above-described respective components (such as the signal processing unit 32), thereby installing the program on the hard disk. This method may also realize the above-described embodiment.

1. A distortion measuring device comprising:
a Brillouin scattered light spectrum recorder that records a spectrum of Brillouin scattered light generated in a device under test as a result of supplying incident light;
an incident light spectrum recorder that records a spectrum of the incident light;
a Brillouin gain spectrum deriver that derives a Brillouin gain spectrum of the device under test based on the recorded spectrum of the Brillouin scattered light and the recorded spectrum of the incident light;
a peak frequency deriver that derives a peak frequency at which the derived Brillouin gain spectrum takes the maximum value; and
a distortion deriver that derives a distortion of the device under test based on the derived peak frequency.

2. The distortion measuring device according to claim 1, wherein said incident light spectrum recorder records a spectrum of Rayleigh scattered light generated in the device under test as the incident light spectrum.

3. A distortion measuring device comprising:
a Brillouin scattered light spectrum recorder that records a spectrum of Brillouin scattered light generated in a device under test as a result of supplying incident light;
a Rayleigh scattered light spectrum recorder that records a spectrum of Rayleigh scattered light generated in the device under test as a result of supplying the incident light;
a Brillouin gain spectrum deriver that derives a Brillouin gain spectrum of the device under test based on the recorded spectrum of the Brillouin scattered light and the recorded spectrum of the Rayleigh scattered light;
a peak frequency deriver that derives a peak frequency at which the derived Brillouin gain spectrum takes the maximum value; and
a distortion deriver that derives a distortion of the device under test based on the derived peak frequency.

4. The distortion measuring device according to claim 2, wherein the spectrum of the Brillouin scattered light and the spectrum of the Rayleigh scattered light relate to the same position in the device under test.

5. The distortion measuring device according to claim 1, comprising:
a continuous wave light source that generates continuous wave light;
an optical pulse generator that converts the continuous wave light into pulsed light;
an optical frequency shifter that receives the continuous wave light, and outputs shifted light including the continuous wave light, first side band light having an optical frequency higher than an optical frequency of the continuous wave light by a predetermined optical frequency, and second side band light having an optical frequency lower than the optical frequency of the continuous wave light by the predetermined optical frequency;
a heterodyne optical receiver that receives scattered light from an incident end of the device under test which the pulsed light enters, further receives the shifted light from said optical frequency shifter, and outputs an electric signal having a frequency which is a difference between the optical frequency of the scattered light and the optical frequency of the shifted light;
a Brillouin scattered light spectrum extractor that extracts an electric signal corresponding to the Brillouin scattered light from the electric signal; and
a Rayleigh scattered light spectrum extractor that extracts an electric signal corresponding to the Rayleigh scattered light from the electric signal.

6. A distortion measuring method comprising:
recording step of recording a spectrum of Brillouin scattered light generated in a device under test as a result of supplying incident light;
recording step of recording a spectrum of the incident light;
deriving step of deriving a Brillouin gain spectrum of the device under test based on the recorded spectrum of the Brillouin scattered light and the recorded spectrum of the incident light;
deriving a peak frequency at which the derived Brillouin gain spectrum takes the maximum value; and
deriving a distortion of the device under test based on the derived peak frequency.

7. A computer readable medium having a program of instructions for execution by a computer to perform a distortion measuring process, the computer readable medium comprising:
a Brillouin scattered light spectrum recording segment for recording a spectrum of Brillouin scattered light generated in a device under test as a result of supplying incident light;
an incident light spectrum recording code segment for recording a spectrum of the incident light;
a Brillouin gain spectrum deriving code segment for deriving a Brillouin gain spectrum of the device under test based on the recorded spectrum of the Brillouin scattered light and the recorded spectrum of the incident light;
a peak frequency deriving code segment for deriving a peak frequency at which the derived Brillouin gain spectrum takes the maximum value; and
a distortion deriving code segment for deriving a distortion of the device under test based on the derived peak frequency.

8. A distortion measuring method comprising:
recording step of recording a spectrum of Brillouin scattered light generated in a device under test as a result of supplying incident light;
recording step of recording a spectrum of Rayleigh scattered light generated in the device under test as a result of supplying the incident light;
deriving a Brillouin gain spectrum of the device under test based on the recorded spectrum of the Brillouin scattered light and the recorded spectrum of the Rayleigh scattered light;
deriving a peak frequency at which the derived Brillouin gain spectrum takes the maximum value; and
deriving a distortion of the device under test based on the derived peak frequency.

9. A computer-readable medium having a program of instructions for execution by a computer to perform a distortion measuring process, the computer readable medium comprising:
a Brillouin scattered light spectrum recording code segment for recording a spectrum of Brillouin scattered light generated in a device under test as a result of supplying incident light;
a Rayleigh scattered light spectrum recording code segment for recording a spectrum of Rayleigh scattered light generated in a device under test as a result of supplying the incident light;
a Brillouin gain spectrum deriving code segment for deriving a Brillouin gain spectrum of the device under test based on the recorded spectrum of the Brillouin scattered light and the recorded spectrum of the Rayleigh scattered light;
a peak frequency deriving code segment for deriving a peak frequency at which the derived Brillouin gain spectrum takes the maximum value; and
a distortion deriving code segment for deriving a distortion of the device under test based on the derived peak frequency.
